(19) United States
(12) Patent Application Publication
(10) Pub. No.: US 2014/0305277 A1
(43) Pub. Date: Oct. 16, 2014

(54) METHOD AND APPARATUS FOR IDENTIFYING KEY-DAMPER HALF REGION OF KEYBOARD MUSICAL INSTRUMENT

(71) Applicant: YAMAHA CORPORATION, HAMAMATSU-SHI (JP)

(72) Inventors: Yuji FUJIWARA, Hamamatsu-shi (JP); Yasuhiko OBA, Hamamatsu-shi (JP)

(73) Assignee: YAMAHA CORPORATION, HAMAMATSU-SHI (JP)

(21) Appl. No.: 14/250,962

(22) Filed: Apr. 11, 2014

(30) Foreign Application Priority Data
Apr. 11, 2013 (JP) 2013-082848

(51) Int. Cl. G10C 3/26

(52) U.S. Cl. CPC G10C 3/26
USPC 84/225

(57) ABSTRACT

For each key and without damping action of dampers deactivated by a damper pedal, loads imposed on a portion of the key acting on the damper are measured while the key is moved over one stroke in at least one of key-depressing and key-releasing directions, in association with a plurality of stroke positions in the one stroke of the key. For each key, a key-damper half region is identified on the basis of relationship between the individual stroke positions and the measured loads corresponding to the stroke positions. Then, on the basis of the key-damper half regions identified for the individual keys, a half point is determined separately for each of the keys, or a half point common to a group of a plurality of the keys is determined.

### BACKGROUND

The present invention relates generally to a method and apparatus for identifying a key-damper half region existing in relationship between each key and a corresponding damper, as well as a non-transitory computer-readable storage medium storing instructions for causing a computer to perform such a method.

Typically, keyboard musical instruments, which are constructed to generate a tone in response to striking of a string set (each string set comprising one or more strings), have, for each of keys, a damper that is brought into and out of contact with the corresponding string set. As well known, the keyboard musical instruments are provided with a loud pedal (damper pedal) for controlling behavior of the dampers. Generally, in a depression stroke of the loud pedal (damper pedal), there exist three different regions: a “play region (or rest region)” where no influence of depression of the loud pedal is transmitted to the dampers; a half pedal region from a point where reduction of pressing contact force applied from the dampers to the string sets is started to a point where the dampers are brought out of contact with the string sets; and a “string-releasing region” where, following the above-mentioned half pedal region, the dampers are completely spaced from the string sets.

Also known are keyboard musical instruments which can be caused to execute an automatic performance, including pedal operation, by supplying a driving electric current to a solenoid coil to drive a pedal in accordance with performance data. In an automatic performance on such a keyboard musical instrument, it is desirable, particularly in order to enhance reproducibility of the performance, that appropriate control be performed on the loud pedal and the like to provide appropriate pedal operation matching the above-mentioned half pedal region. For example, in performing feedback control etc. of pedal operation based on performance data, it would be important to properly identify the half pedal region and have the identified half pedal region reflected in the control.

Thus, there have heretofore been proposed methods or techniques for accurately and easily identifying a half pedal region and a half point present in that half pedal region. Japanese Patent No. 4524798, for example, discloses a technique for observing driving loads of a pedal to identify a half point of the pedal. Further, Japanese Patent Application Laid-open Publication No. 2007-292921 discloses detecting vibrations of a soundboard to identify a half point of the pedal.

As known, the dampers are provided in corresponding relation to the keys. In response to a depression operation of any one of the keys, the corresponding damper is brought out of contact with the corresponding string set. In response to a release operation of any one of the keys, the corresponding damper is brought back into contact with the corresponding string set. In relationship between each of the keys and the corresponding damper too, there exist three different regions similar to the aforementioned three regions of the pedal. The half region in relationship between the key and the damper corresponding to the key will hereinafter be referred to as “key-damper half region”. In automatically driving the keys for an automatic performance too, it is desirable to control driving of the individual keys, during tone generation control, in accordance with characteristics of timing at which the dampers and string sets corresponding to the keys are brought into and out of contact with each other (or characteristics of positional relationship between the dampers and the string sets) and with the aforementioned three regions (particularly “key-damper half region”) taken into consideration.

Until today, the concept of the “key-damper half region” has not been deeply considered. However, the inventors of the present invention think that deep consideration about the key-damper half region is necessary in order to realize more delicate performance expressions. As the simplest approach, it is conceivable to set the key-damper half regions such that a same stroke position is made a half point for all of the keys. However, the individual “key-damper half regions” may differ subtly from one key to another depending on unevenness in factors, such as size, position and resiliency, of the individual dampers and may also vary due to changes over time of such factors. Thus, with the aforementioned simplest approach, unique key-damper half regions of the individual keys cannot be identified, and thus, it is difficult to realize in an automatic performance delicate performance expressions taking into account the key-damper half regions. Namely, a very effective approach or technique for accurately identifying a key-damper half region per key has been neither considered nor established till now.

### SUMMARY OF THE INVENTION

In view of the foregoing prior art problems, the present invention seeks to provide a technique for accurately identifying a key-damper half region per key.

Note that, in this specification, the terms “sound” and “tone” are used interchangeably with each other.

In order to accomplish the above-mentioned object, the present invention provides an improved method for identifying a key-damper half region in a keyboard musical instrument, the keyboard musical instrument including: a plurality of keys; a plurality of dampers provided in corresponding relation to the keys and each configured to activate its damping action in response to release of a corresponding one of the keys and deactivate its damping action in response to depression of the corresponding key; and a damper pedal configured to be capable of deactivating the damping action of the plurality of dampers, which comprises: a measurement step of measuring, for each of the keys and with the damping action of the plurality of dampers not deactivated by the damper pedal, loads imposed on a portion of the key acting on the damper while the key is moved over one stroke in at least one of key-depressing and key-releasing directions, in association with individual ones of a plurality of stroke positions in the one stroke of the key; and an identification step of identifying, for each of the keys, the key-damper half region on the basis of relationship between the individual stroke positions and the measured loads corresponding to the individual stroke positions.

According to the present invention, a key-damper half region can be identified accurately for each of the keys. Such key-specific key-damper half regions identified in the aforementioned manner can be used advantageously in various scenes. For example, the identified key-specific key-damper half regions may be stored in a memory, so that, when an automatic performance is to be executed on the keyboard musical instrument, an automatic performance using key-damper half regions can be executed appropriately in accordance with information of the stored key-specific key-damper half regions.

According to one embodiment, the method may further comprise a step of determining a half point for each of the keys on the basis of the key-damper half region identified for the key. Further, the method may further comprise a step of determining a half point common to a key group of a plurality of the keys on the basis of the key-damper half region identified for each of the keys.

According to one embodiment, the keyboard musical instrument may further include a key drive unit configured to be capable of driving the plurality of keys independently of each other, and the measurement step may measure, for each of the keys, loads imposed on the key drive unit while the key is moved over one stroke in at least one of the key-depressing and key-releasing directions, in association with the individual stroke positions in the one stroke of the key. With such arrangements, automatic measurement processing can be performed.

According to one embodiment, the method further comprises a step of measuring, as offset loads for each of the keys and with the damping action of the plurality of dampers deactivated by the damper pedal, loads imposed on the portion of the key acting on the damper while the key is moved over the one stroke in at least one of the key-depressing and key-releasing directions, in association with the individual stroke positions in the one stroke of the key. The identification step may include a step of calculating compensated loads by canceling the offset loads from the loads measured by the measurement step with the damping action of the plurality of dampers not deactivated by the damper pedal, and, for each of the keys, the identification step may identify the key-damper half region on the basis of the relationship between the individual stroke positions and the compensated loads corresponding to the individual stroke positions. With such arrangement, the key-damper half regions can be identified for the individual keys with an even higher accuracy.

The present invention may be constructed and implemented not only as the method invention discussed above but also as an apparatus invention. Also, the present invention may be arranged and implemented as a software program for execution by a processor, such as a computer or DSP, as well as a non-transitory computer-readable storage medium storing such a software program. In this case, the program may be provided to a user in the storage medium and then installed into a computer of the user, or delivered from a server apparatus to a computer of a client via a communication network and then installed into the client's computer. Further, the processor used in the present invention may comprise a dedicated processor with dedicated logic built in hardware, not to mention a computer or other general-purpose processor capable of running a desired software program.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

Certain preferred embodiments of the present invention will hereinafter be described in detail, by way of example only, with reference to the accompanying drawings, in which:

FIG. 1 is a partly sectional view showing a construction of a keyboard musical instrument having applied thereto an apparatus for identifying a key-damper half region according to an embodiment of the present invention, Which particularly shows the keyboard musical instrument construction in relation to a given key;

FIG. 2 is a block diagram showing an example hardware construction of a control device of the keyboard musical instrument;

FIGS. 3A to 3E are schematic views showing behavior of a damper in a key-depressing forward stroke;

FIG. 4 is a conceptual diagram explanatory of how the key-damper half region is measured according to the embodiment;

FIG. 5 is a flow chart showing an operational sequence of processing for identifying a key-damper half region and determining a half point on the basis of the identified key-damper half region;

FIG. 6 is a diagram showing a load characteristic curve and approximate straight lines of the load characteristic curve;

FIG. 7 is a block diagram showing data and control flows involved in servo drive for a load characteristic curve calculation process: and

FIG. 8 is a flow chart showing a detailed example operational sequence of the load characteristic curve calculation process performed during the processing of FIG. 5.

### DETAILED DESCRIPTION

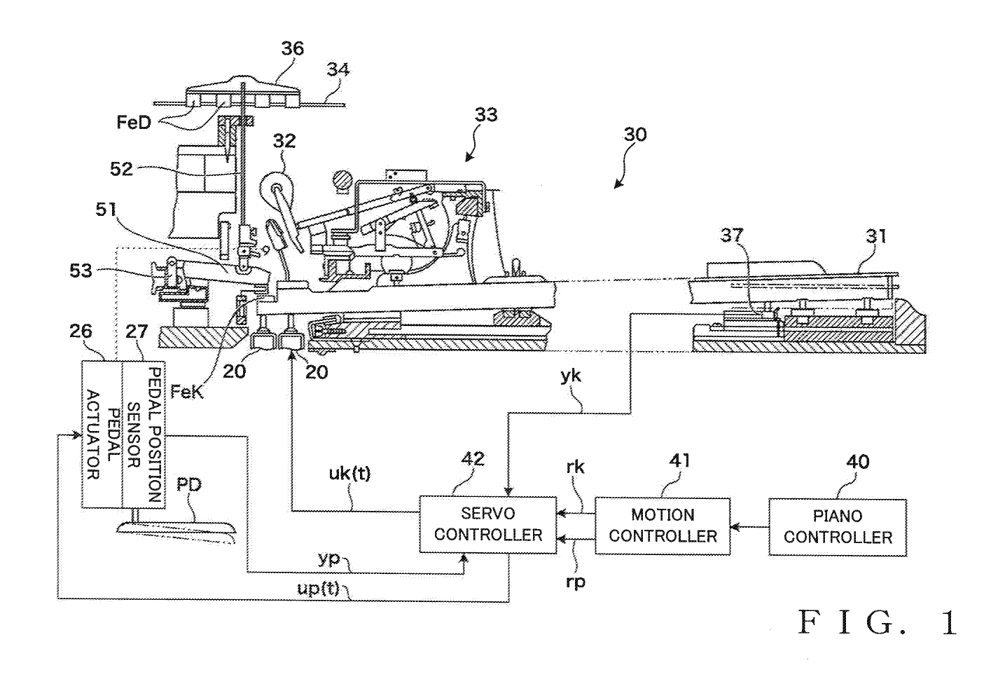

FIG. 1 is a partly sectional view showing a construction of a keyboard musical instrument 30 having applied thereto an apparatus for identifying a key-damper half region according to an embodiment of the present invention, which particularly the keyboard musical instrument construction in relation to a given key. The keyboard musical instrument 30 is constructed as an auto-playing piano (player piano). Like an ordinary acoustic piano, the keyboard musical instrument 30 includes, for each of a plurality of keys 31, an action mechanism 33 for transmitting motion of the key 31 to a hammer 32; a string set 34, comprising one or more strings (sounding elements), to be struck by the hammer 32; and a damper 36 for stopping vibrations of the string set 34. Note, however, that the damper 36 is not provided for keys 31 in a predetermined high pitch range.

A side of the keys 31 closer to a human player will hereinafter referred to as “front”. Although it is assumed here that the apparatus for identifying a key-damper half region is incorporated integrally in the keyboard musical instrument 30, the present invention is not so limited, and the apparatus for identifying a key-damper half region may be constructed separately from the keyboard musical instrument 30 in such a manner that it can communicate with the keyboard musical instrument 30.

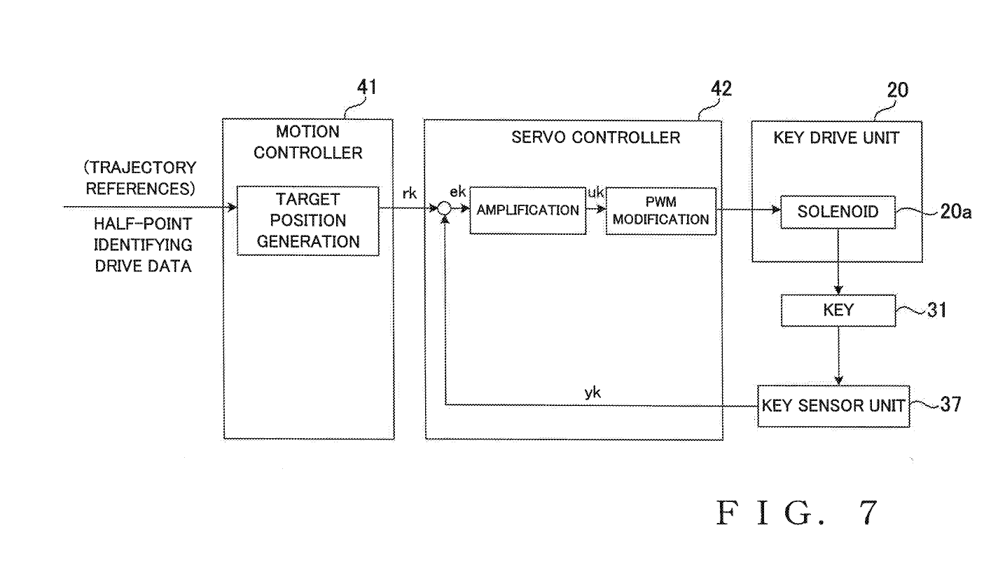

In the keyboard musical instrument 30, a key drive unit 20 including a solenoid 20a (FIG. 7) is provided for each of the keys 31 and located beneath a rear end portion of the key 31. Further, a key sensor unit 37 is provided for each of the keys 31 and located beneath a front end portion of the key 31, and the key sensor unit 37 continuously detects a stroke position of the key 31 during depression and release operations of the key 31 to thereby output a detection signal (yk) corresponding to a result of the detection.

A sensor applied to the key sensor unit 37 includes, for example; a light emitting diode (LED), a light sensor for receiving light emitted from the light emitting diode to thereby output a detection signal corresponding to an amount of the received light; and a light blocking plate for Changing an amount of light to be received by the light sensor in accordance with a depressed amount of the key 31. The detection signal (yk) which is an analog signal output from the key sensor unit 37 is converted into a digital signal via a not-shown A/D converter and then supplied to a servo controller 42.

Once a drive signal is supplied to the key drive unit 20 of a key corresponding to a sound or tone pitch defined by note-on event data included in performance data, a plunger of the key drive unit 20 ascends to push up a rear end portion of the corresponding key 31. Thus, the key 31 is automatically depressed and the string set 34 corresponding to the depressed key 31 is struck by the hammer 32, so that a piano sound is automatically generated.

The keyboard musical instrument 30 also includes: a pedal PD that is a loud pedal (damper pedal) for driving the dampers 36; a pedal actuator 26 for driving the pedal PD; and a pedal position sensor 27 for detecting a position of the pedal PD. The pedal position sensor 27 may be of a generally similar construction to the sensor applied to the key sensor unit 37. The pedal actuator 26 includes a solenoid coil (not shown) and a plunger (not shown) connected to the pedal PD, and it is constructed in such a manner that, once a drive signal is supplied, the plunger moves to drive the pedal PD so that the pedal PD can be automatically depressed and released.

Except for the predetermined high pitch range, the dampers 36 are provided in corresponding relation to the keys 31. Once the pedal PD is depressed, all of the dampers 36 together move upward or ascend. But, when the pedal PD is not in the depressed state, only the damper 36 corresponding to a depressed key 31 ascends and then descends to its original position in response to release of the corresponding key 31. Namely, the damper 36 is constructed to activate its damping action on the corresponding key 31 (i.e., on vibrations of the string set 34) in response to release of the key 31 and cancel or deactivate its damping action in response to depression of the key 31. Further, the damper pedal PD is constructed to be capable of collectively canceling or deactivating the damping action of the plurality of dampers 36.

Mechanisms related to the dampers 36 may be of the well-known type. As an example, a damper lever Si is pivotably supported at its rear end portion on a damper lever flange 53 fixed to the keyboard musical instrument, a damper wire 52 is connected to a front portion of the damper lever 51, and the damper 36 is provided on an upper end portion of the damper wire 52. The damper 36 has damper felt sets FeD (hereinafter referred to as “damper felt Fed”) that are brought into and out of contact with the string set 34, and a damper lever cushion felt (hereinafter referred to “key felt FeK”) is provided on an upper rear end portion of the key 31.

In a non-key-depressed state, the damper felt FeD is held in abutting contact with the string set 34 by the own weight of the damper 36. Once the key is depressed, the corresponding key felt FeK drives the damper lever 51 so that the damper lever 51 pivots in a counterclockwise direction of FIG. 1. Thus, the corresponding damper 36 ascends via the damper wire 52, so that the damper felt FeD of the damper 36 is brought out of contact with the string set 34.

Further, the keyboard musical instrument 30 may include, for execution of an automatic performance, a piano controller 40, a motion controller 41 and the servo controller 42. The piano controller 40 supplies performance data to the motion controller 41. The performance data comprise, for example, MIDI (Musical Instrument Digital Interface) codes and may include key drive data that specifically defines, for each of the keys 31, time-vs.-position relationship during depression and release strokes of the key 31. The performance data may also include pedal drive data that specifically defines time-vs.-position relationship during a depression stroke of the pedal PD. The motion controller 41 is constructed to generate, on the basis of the pedal drive data and pedal drive data included in the supplied performance data, target position data rp and rk indicative of respective target positions of the pedal PD and keys 31 momently changing with respect to time t and supply the generated target position data rp and rk to the servo controller 42. Meanwhile, a detection signal of the pedal position sensor 27 is supplied as a feedback signal yp to the servo controller 42, and similarly a detection signal of the key sensor unit 37 is supplied as a feedback signal yk to the servo controller 42. Note that a signal output from the solenoid 20a of the key drive unit 20 may be used as the above-mentioned feedback signal yk.

The servo controller 42 generates, for each of the pedal PD and keys 31, an energizing electric current instructing value up(t), uk(t) corresponding to a deviation between the target position data rp, rk and the feedback signal yp, yk, and it supplies the thus-generated electric current instructing values up(t) and uk(t) to the pedal actuator 26 and the key drive unit 20, respectively. For example, the energizing electric current instructing values up(t) and uk(t) are indicative of average energizing electric currents to be fed to the solenoid coils of the pedal actuator 26 and the key drive unit 20, respectively. Actually, these energizing electric current instructing values up(t) and uk(t) may each be in the form of a PWM signal having been subjected to pulse width modulation in such a manner as to have a duty ratio corresponding to the average energizing electric current.

In an automatic performance based on automatic performance data, the servo controller 42 performs servo control by comparing corresponding ones of the target position data rp and rk and the feedback signals yp and yk and outputting the electric current instructing values up(t) and uk(t) after updating the same as necessary in accordance with deviations between the compared data rp and rk and the feedback signals yp and yk so that the feedback values reach the corresponding target values. In this way, the automatic performance is executed by the shift pedal PD and the keys 31 being driven in accordance with the performance data.

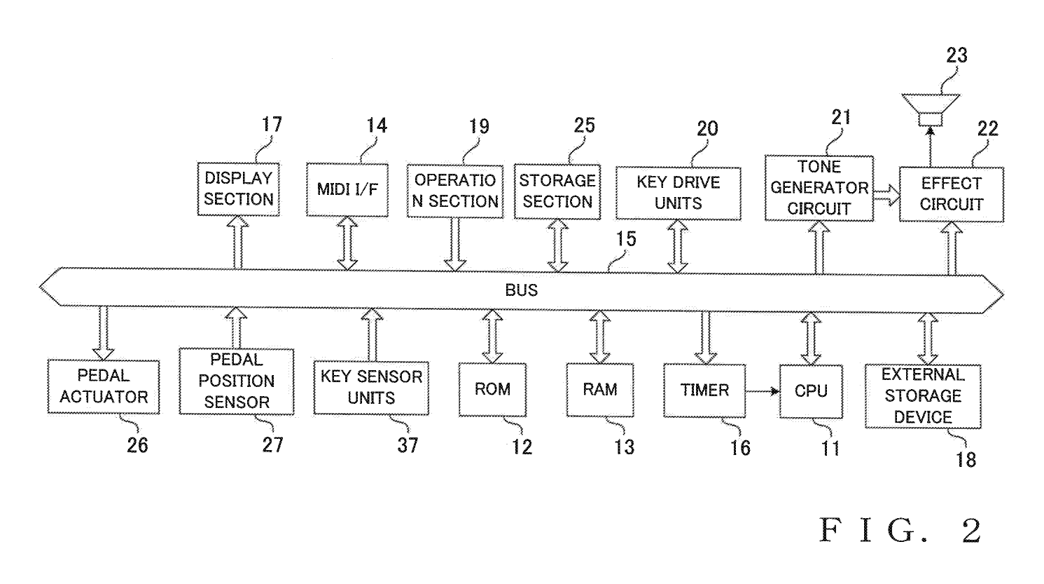

FIG. 2 is a block diagram showing an example hardware construction of a control device for the keyboard musical instrument 30. The control device for the keyboard musical instrument 30 includes a CPU 11 to which are connected, via a bus 15, the aforementioned key drive units 20, the petal actuator 26, the pedal position sensor 27, the key sensor units 37, a ROM 12, a RAM 13, a MIDI interface ((MIDI I/F) 14, a tinier 16, a display section 17, an external storage device 18, an operation section 19, a tone generator circuit 21, an effect circuit 22 and a storage section 25. A sound system 23 is connected via the effect circuit 22 to the tone generator circuit 21.

The CPU 11 controls the entire keyboard musical instrument 30. The ROM 12 stores therein control programs for execution by the CPU 11 and various data, such as table data. The RAM 13 temporarily stores therein, among other things, various input information, such as performance data and text data, various flags, buffered data and results of arithmetic operations. The MIDI (I/F) 14 inputs, as MIDI signals, performance data transmitted from not-shown MIDI equipment or the like. The timer 16 counts interrupt times in timer interrupt processes and various time lengths. The display section 17 includes, for example, an LCD and displays various information, such as a musical score. The external storage device 18 is capable of accessing a not-shown portable storage medium, such as a flexible disk and reading and writing data, such as performance data, from and to the portable storage medium. The operation section 19, which includes not-shown operators (input members) of various types, is operable to instruct a start/stop of an automatic performance, instruct selection of a music piece etc. and make various settings. The storage section 25, which comprises a non-volatile memory, such as a flash memory or hard disk, can store various data, such as performance data. An application program for allowing a computer to execute a method for identifying a key-damper half region in accordance with the embodiment of the present invention is stored in a non-transitory computer-readable storage medium, such as the ROM 12 or storage section 25, and such an application program is executable by the CPU 11.

The tone generator circuit 21 converts performance data into tone signals. The effect circuit 22 imparts various effects to the tone signals input from the tone generator circuit 21, and the sound system 23, which includes a D/A (Digital-to-Analog) converter, amplifier, speaker, etc., converts the tone signals and the like input from the effect circuit 22 into audible sounds.

Note that the functions of the motion controller 41 and the servo controller 42 are actually implemented through cooperation among the CPU 11, timer 16, ROM 12, RAM 13, etc. and application programs.

A half region in relationship between each of the keys 31 and the damper 36 corresponding to the key 31 will hereinafter be referred to as “key-damper half region”. Such a key-damper half region can be defined uniquely per key 31 in relation to stroke positions of the key 31. By contrast, a half pedal region of the pedal PD can be defined in relation to the one pedal PD that can commonly act on the dampers 36 of all of the keys 31.

Because the key-damper half region differs subtly from one key to another, it is necessary to identify in advance such a key-damper half region for each of the keys 31 in order to appropriately reproduce half-damper states during an automatic performance etc. For example, a portion of the key 31 that is normally depressed with a human player's finger is set as a particular portion to be used in identifying (measuring) a stroke position of the key 31 (key stroke position). Let it be assumed here that the key stroke position is expressed as an amount (mm) of displacement in a key-depressing (forward) direction from a rest position (non-depressed position) of the particular portion of the key. A half point 1-IP within the key-damper half region can be expressed as a key stroke position. Note, however, that any other desired portion, such as a rear end portion, of the key 31 may be set as the particular portion to be used in identifying (measuring) a key stroke position.

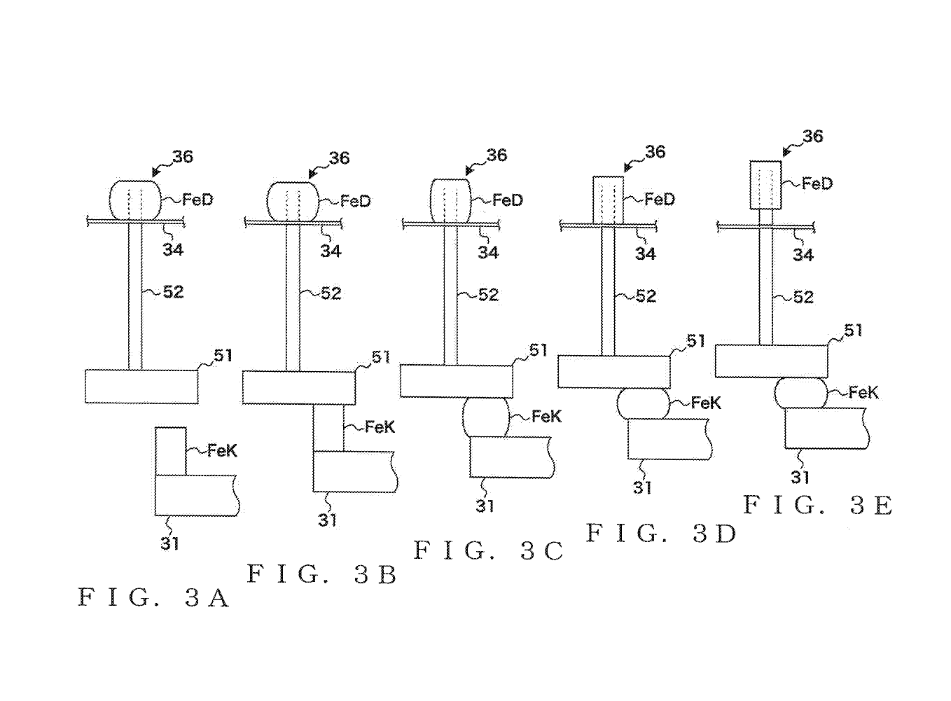

In the forward stroke of key depression (i.e., key-depressing forward stroke), there exist three different regions: a “play region (or rest region)” where no influence of the key depression is transmitted to the damper 36; a “key-damper half region” from a point where reduction of pressing contact of the damper 36 against the string set 34 is started to a point where the damper is brought out of contact with the string set; and a “string-releasing region” Where, following the key-damper half region, the damper 36 is completely spaced from the string set 34, as will be detailed hereinbelow in relation to FIG. 3,

FIGS. 3A to 3E are schematic views showing behavior of the key 31 and the damper 36 in the key-depressing forward stroke. Main elements which exert resiliency among various elements from the key 31 to the damper 36 are the damper felt FeD provided on the damper 36 and the key felt FeK. Influences of the other elements can be ignored because they are merely nominal. These damper felt Fe′) and key felt FeK can be considered as modeled as linear springs that have their respective predetermined spring constants. To ease visual understanding, FIGS. 3A to 3E show the damper felt FeD and key felt FeK in their most expanded state as circular cylindrical blocks (rectangular blocks as viewed in side elevation) and show the felts FeD and FeK in their compressed state as centrally-expanded blocks. Further, in FIGS. 3A to 3E, the damper lever 51 and the key 31 are assumed to move vertically straight although they pivot as a matter of fact.

In the non-key-depressed state shown in FIG. 3A, the damper felt FeD is in its most compressed state while the key felt FeK is in its most expanded state. A time point when the key felt FeK abuts against the damper lever 51 as shown in FIG. 3B in response to depression of the key 31 from the non-key-depressed state corresponds to a start point of the key-damper half region, i.e. half region start point stS. As the key 31 is depressed further, the key felt FeK is compressed and the damper wire 52 ascends together with the damper lever 51, while the compressed state of the damper felt FeD is lessened gradually.

Then, an end point of the key-damper half region, i.e. a half region end point stE, is reached (FIG. 3D) by way of the half point HP (FIG. 3C) that is a substantially middle point in the key-damper half region. At this time point, the key felt FeK is in its most compressed state while the damper felt FeD is in its most expanded state as shown in FIG. 31). Namely, this time point corresponds to a limit (lowermost) position where the damper felt FeD can stay in contact with the string set 34 in the key-depressing forward stroke. As the key 31 is depressed further, the damper felt FeD moves upward away from the string set 34 as shown in FIG. 3E.

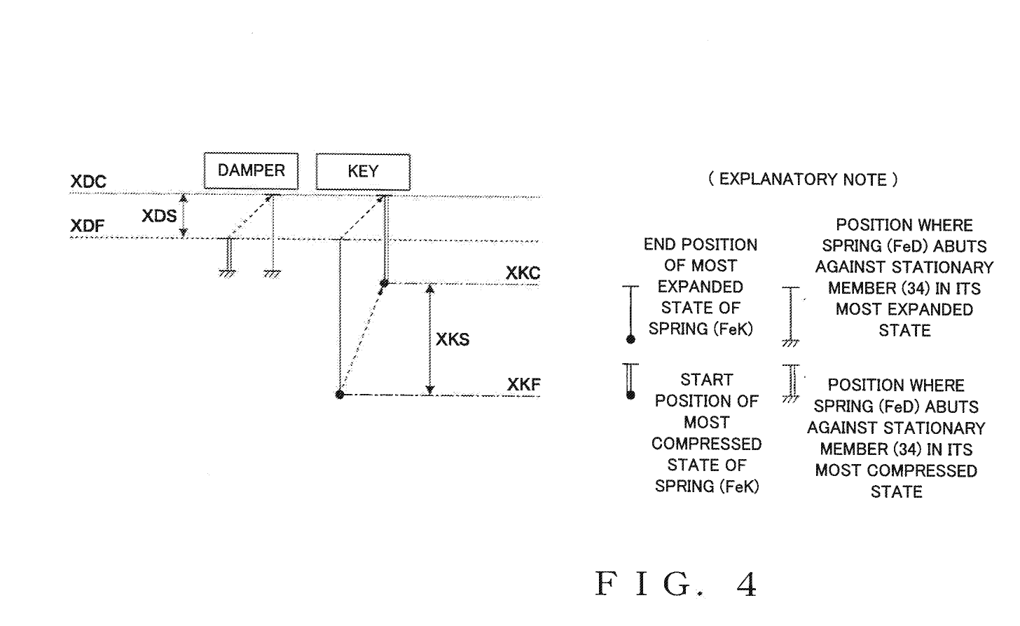

FIG. 4 is a conceptual diagram explanatory of how the key-damper half region is measured. Positions XKF and XKC indicate stroke positions of the key 31 corresponding to the states of FIGS. 3B and 3D, respectively. The position XKF corresponding to the state of FIG. 3B is a position where the key felt FeK in the most expanded state starts to abut against the damper lever 51 (i.e., where the most expanded state ends). As the key 31 is depressed further from the position XKF, the key felt FeK is compressed gradually. The position XKC corresponding to the state of FIG. 3D is a position where the key felt FeK has reached its most compressed state (i.e., where the most compressed state starts). As the key 31 is depressed further from the position XKC, the damper lever 51 is pushed up with the key felt FeK kept in the most compressed state, so that the damper felt FeD can be reliably moved away from the string set 34. A range XKS defined between the position XKF and the position XKC corresponds to the key-damper half region.

Positions XDF and XDC shown in FIG. 4 represents upper end positions (as viewed in FIG. 3) of the damper felt FeD corresponding to the stroke positions XKF and XKC of the key 31. The position XDF corresponding to the state of FIG. 313 is a position Where the damper felt FeD is in abutting engagement with the stationary member (string set 34) in its most compressed state. As the key 31 is depressed further from the position XDF, the damper lever 51 is pushed up gradually; so that the damper felt FeD expands gradually. The position XDC corresponding to the state of FIG. 3D is a position where the damper felt FeD is in abutting engagement with the stationary member (string set 34) in its most expanded state. As the key 31 is depressed further from the position XDC, the damper lever 51 is pushed up while keeping the most expanded state of the damper felt FeD, so that the damper felt FeD can be reliably moved away from the string set 34. A difference XDS between the position XDF and the position XDC (XDS=XDC−XDF) represents an expansion/compression amount when the damper felt FeD is considered alone or independently.

According to the instant embodiment, it is not necessary to separately measure or identify a half region of the damper felt FeD. Namely, the instant embodiment measures the stroke positions XKF and XKC of the key 31 in order to identify a key-damper half region based on a combination of the damper felt FeD and the key felt FeK.

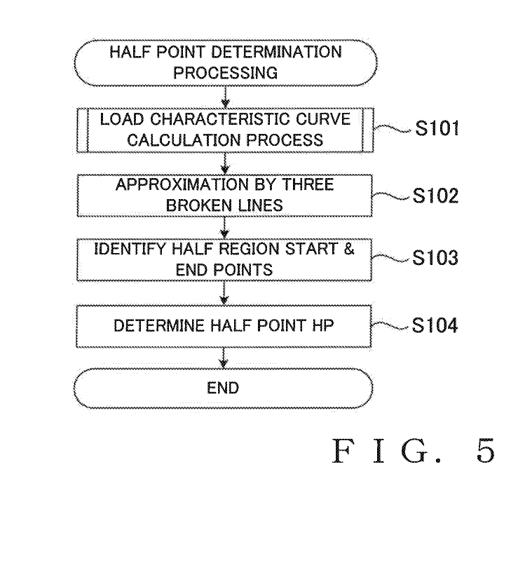

FIG. 5 is a flow chart showing an operational sequence of processing for identifying a key-damper half region and determining a half point HP on the basis of the identified key-damper half region. Such processing of FIG. 5 is performed by the CPU 11 for each of the keys 31.

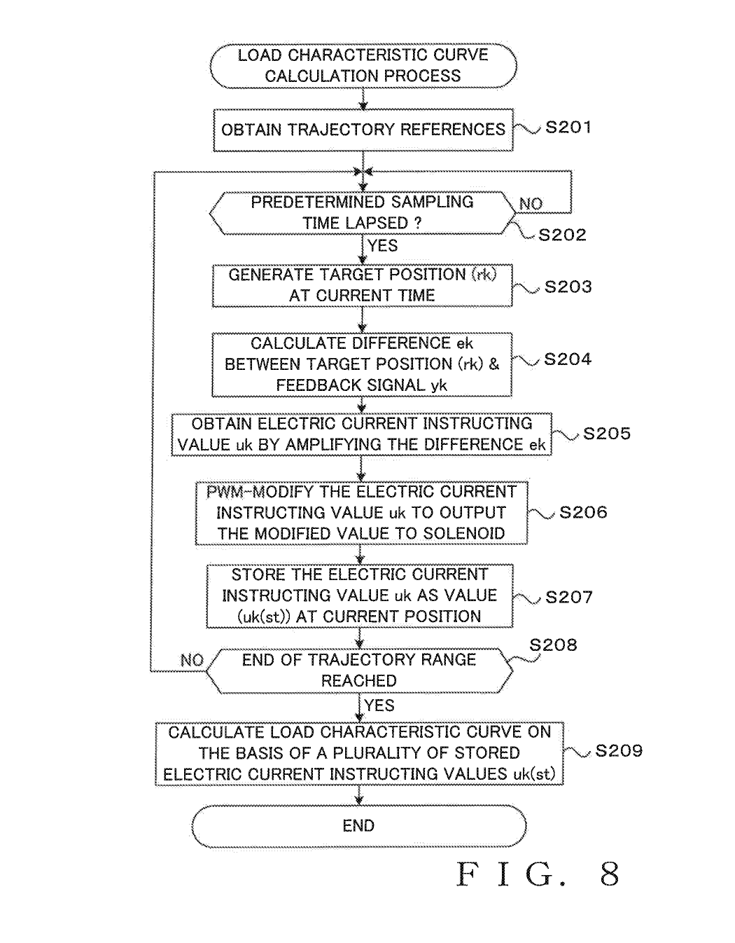

First, at step S101, the CPU 11 performs a later-described load characteristic curve calculation process of FIG. 8 to thereby calculate a load characteristic curve CA indicative of loads imposed on the key drive unit 20 versus stroke positions of the key 31 when the key 31 is driven in the key-depressing forward direction. Let it be assumed here that, in this process, the pedal PD is kept at a position (e.g., non-depressed position) closer to the rest position than the half pedal region in the relationship between the pedal PD and the dampers 36, i.e. the pedal PD is kept in a non-activated state where it does not execute collective deactivation of the damping action of the dampers 36.

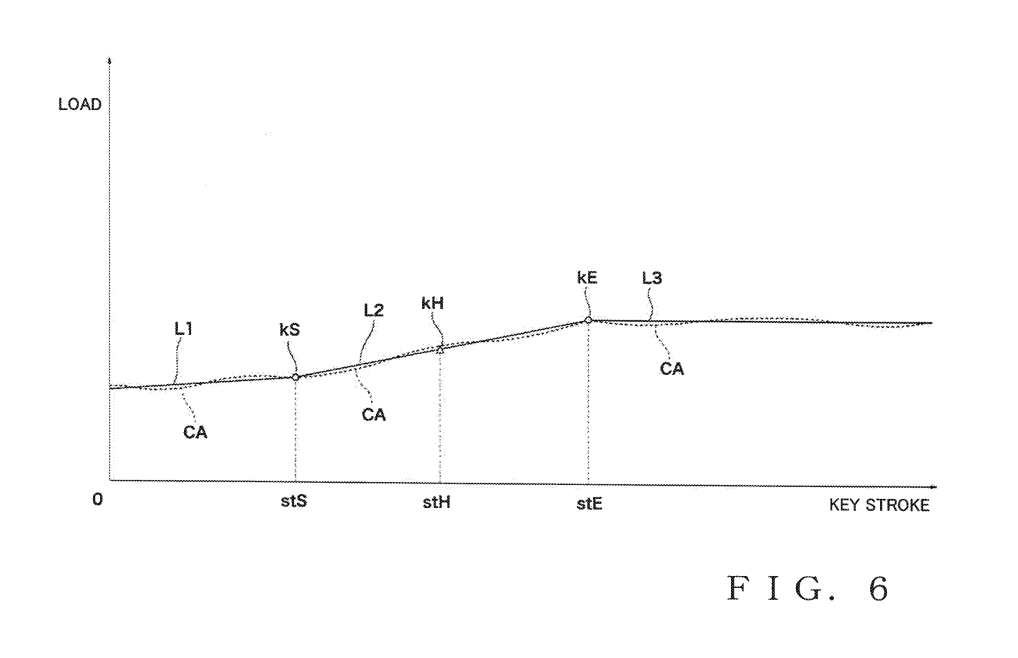

FIG. 6 is a diagram showing the load characteristic curve CA and approximate straight lines L1 to L3 of the load characteristic curve CA. In FIG. 6, the horizontal axis represents stroke positions st of the key 31 corresponding to various amounts of depression from the non-key-depressed position, while the vertical axis represents loads imposed on the key drive unit 20 (later-described electric current instructing values uk(st)). Note that the loads imposed on the key drive unit 20 are equivalent to loads imposed on a portion of the key 31 acting on the damper 36. Here, the portion of the key 31 acting on the damper 36 is, for example, a portion of the key 31 which the solenoid 20a of the key drive unit 20 abuts against, or the key felt FeK and a portion of the key 31 having the key felt FeK provided thereon, or a portion of the damper lever 51 which the key felt FeK abuts against.

Note that, because a weight of the action mechanism 33 including the hammer 32 influences the key drive unit 20, some difficulty would be involved in detecting loads over a very wide range in the key depression stroke. Thus, an approximate key-damper half region may be estimated in advance so that loads are detected using, as a trajectory range (or section), a stroke range assumed to certainly contain the thus-estimated key-damper half region, instead of being detected in the entire stroke.

FIG. 7 is a block diagram showing data and control flows involved in servo drive for the load characteristic curve calculation process, and FIG. 8 is a flow chart showing an example operational sequence of the load characteristic curve calculation process performed at step S101b of the processing of FIG. 5.

According to the instant embodiment, “half-point identifying drive data” for driving the key 31 at a substantially constant speed is prepared in advance. Like the above-mentioned performance data, the half-point identifying drive data is supplied from the piano controller 40 to the motion controller 41, so that target position data corresponding to the half-point identifying drive data is supplied to the servo controller 42. In turn, the servo controller 42 performs feedback control to supply the solenoid 20a of the key drive unit 20 with an electric current instructing value uk(t) based on the target position data corresponding to the half-point identifying drive data (such an electric current instructing value uk(t) will hereinafter be referred to particularly as “electric current instructing value uk(st)”). Thus, the key 31 is driven by the key drive unit 20 to move in the key-depressing forward direction at a substantially constant speed.

Referring to FIGS. 7 and 8, first, the motion controller 41 obtains a trajectory reference based on the half-point identifying drive data, at step S201. Then, upon lapse of a predetermined sampling time (e.g., 4 msec) (at step S202), the motion controller 41 generates a target position (target position data rk) corresponding to a current time t and outputs the thus-generated target position to the servo controller 42 at step S203.

Then, at step S204, the servo controller 42 receives a feedback signal yk from the key sensor unit 37 and calculates a difference ek between the target position output from the motion controller 41 and the feedback signal yk. Then, the servo controller 42 amplifies the difference ek to obtain an electric current instructing value uk at step S205 and PWM-modifies the electric current instructing value uk(t) to output the PWM-modified electric current instructing value uk to the solenoid 20a of the key drive unit 20 at step S206. Thus, the key 31 is driven on the basis of the electric current instructing value uk, and a position st of the key 31 is detected by the key sensor unit 37 and fed back to the servo controller 42 as a feedback signal yk.

Then, at step S207, the servo controller 42 stores into a storage device, such as the RAM 13, the output electric current instructing value uk as a value at the current position, i.e. as an electric current instructing value uk(st) corresponding to the stroke position st of the key 31 indicated by the current feedback signal yk. Then, the aforementioned operations of steps S202 to S207 are repeated until an end of the trajectory range is reached as determined at step S208. Finally, a load characteristic curve CA is calculated at step S209 on the basis of a plurality of electric current instructing values uk(st) stored in the storage device, after which the load characteristic curve calculation process of FIG. 8 is brought to an end.

Alternatively, the aforementioned load characteristic curve calculation process may be performed a plurality of times (e.g., ten times) to thereby store a plurality of pieces of load information (electric current instructing values uk(st)) for the same target position. As another alternative, an average of the plurality of pieces of load information obtained for the same target position may be calculated, and the thus-calculated average may be set as the electric current instructing value uk(st).

Further, in the instant embodiment, the stroke position st of the key 31 represents a value based on the feedback signal yk that is a detection signal of the key drive unit 20. Further, the load imposed on the key drive unit 20 represented on the vertical axis of FIG. 6 represents the electric current instructing value uk(st) that is output from the servo controller 42 in the process of FIG. 8. The load characteristic curve CA of FIG. 6 indicates a variation of the electric current instructing values uk(st) versus the positions st of the key 31 when the key 31 is driven at a substantially constant slow speed.

Note that the process of FIG. 8 has been described as measuring loads imposed on the key drive unit 20 while moving the key 31 in the key-depressing forward stroke direction. However, the present invention is not so limited. For example, as an alternative, a mechanism for controlling movement of the key 31 in a returning stroke direction (key-releasing direction) may be provided so that the process of FIG. 8 can measure loads imposed on the key drive unit 20 while moving the key 31 in the key-releasing returning stroke direction. As another alternative, a single load characteristic curve CA may be obtained, for example, by averaging two curves obtained from movement of the key 31 in both of the key-depressing forward stroke direction and key-releasing returning stroke direction.

The process of step S101 of FIG. 5, i.e. operations of steps S201 to S209 of FIG. 8, performed by the CPU 11 correspond to measuring, for each of the keys 31 and with the damping action of the plurality of dampers not deactivated by the damper pedal PD, loads imposed on a portion of the key 31 acting on the damper 36 while the key 31 is moved over one stroke in at least one of the key-depressing and key-releasing directions, in association with a plurality of stroke positions in the one stroke of the key 31. As another example, the process of step S101 of FIG. 5, i.e. operations of steps S201 to S209 of FIG. 8, may be implemented not only by a software program executable by a processor but also by a dedicated control device constructed of integrated circuitry, DSP or the like.

Next, at step S102 of FIG. 5, the CPU 11 performs a straight line approximation operation for approximating the load characteristic curve CA, obtained in the aforementioned manner, by three broken lines. As a consequence, the load characteristic curve CA is approximated by the first to third straight lines L1 to L3 as shown in FIG. 6. In FIG. 6, kS indicates an intersection point (bending point) between the first straight line L1 and the second straight line L2, and kE indicates an intersection point (bending point) between the second straight line L2 and the third straight line U.

Then, at step S103 of FIG. 5, a half region start point stS and a half region end point stE are identified on the basis of the bending points kS and kE. Namely; the bending points kS and kE represent two sudden change points where the load characteristic curve CA suddenly changes in inclination, and thus, these bending points kS and kE can be regarded as corresponding respectively to a time point when reduction of pressing contact force of the damper 36 against the string set 34 starts and a time point when the damper 36 is brought out of contact with the string set 34. Thus, in the instant embodiment, a position of the key 31 corresponding to the bending point kS is identified as the half region start point stS, and a position of the key 31 corresponding to the bending point kE is identified as the half region end point stE.

If the stroke of the key 31 is divided, at the half region start point stS and the half region end point stE, into three segments, the segment from the half region start point stS to the half region end point stE is the “key-damper half region”. The segment from a “0” position to the half region end point stE of the key 31 is the “rest region”, and the segment from the half region end point stE to a depression end (fully-depressed) position of the key 31 is the “string-releasing region”. Thus, the “key-damper half region” is identified at step S103. Namely, the operation of step S103 performed by the CPU 11 corresponds to identifying, for each of the keys 31, the key-damper half region on the basis of relationship between the individual stroke positions and the measured loads corresponding to the stroke positions. As an alternative, the operation of step S103 may be implemented not only by a software program executable by a processor but also by a dedicated control device constructed of the integrated circuitry, DSP or the like.

Next, at step S104 of FIG. 5, a half point HP is determined on the basis of the bending points kS and kE, or the half region start point stS and the half region end point stE. Namely, a point at which the segment from the half region start point stS to the half region end point stE is divided in accordance with a predetermined internal division ratio is determined as the half point HP. In the instant embodiment, “1:1” is employed as the predetermined internal division ratio, and thus, a position stH is determined as the half point. HP as shown in FIG. 6. This position stH is also a position of the key 31 that corresponds to a point kH at which a segment from the bending point kS to the bending point kE is divided in accordance with the predetermined internal division ratio. After that, the processing of FIG. 5 is brought to an end.

Because the half point HP is determined on the basis of the internal division ratio between the half region start point stS and the half region end point stE identified by the straight line approximation of the load characteristic curve CA, the instant embodiment can identify the half point HP accurately and easily. Additionally, because the load characteristic curve CA is obtained as a result of driving the key 31 at a substantially constant slow speed, the half region start point stS and the half region end point stE can be identified with a high accuracy, and the key-damper half region and the half point HP can also be identified with a high accuracy.

The instant embodiment is arranged to obtain, for each of the keys 31 and with the pedal PD kept positioned closer to the rest position than the half pedal region, the load characteristic curve CA that represents relationship between the stroke positions of the key 31 and the loads imposed on the key drive unit 20 obtained when the key 31 is moved based on control of the corresponding key drive unit 20. Then, for each of the keys 31, the key-damper half region can be identified accurately on the basis of the two sudden change points where the load characteristic curve CA suddenly changes in inclination.

Whereas the processing of FIG. 5 has been described as performed separately for each of the keys 31, it may be performed collectively for a plurality of the keys 31. In such a case, the processing of FIG. 5 is performed collectively for individual ones of the plurality of the keys 31 so that key-damper half regions can be collectively identified for the individual keys 31.

The above-described embodiment is arranged to obtain the load characteristic curve CA, indicative of relationship between stroke positions of the key 31 and loads imposed on the key drive unit 20, by performing measurements with the pedal PD kept positioned close to the rest position (i.e., with the damping action of the dampers 36 not collectively deactivated by the damper pedal PD). However, it may sometimes be desired to obtain a load characteristic curve with influences of other mechanisms than the damper 36 (such as the action mechanism 33) on the loads removed therefrom. To meet such a desire, the inventors of the present invention propose an alternative embodiment as described hereinbelow.

Namely, the alternative embodiment is arranged such that, in addition to measuring the loads with the damping action of the dampers 36 not collectively deactivated by the damper pedal PD as above, it measures, as offset loads for each of the keys 31 and with the damping action of the dampers 36 collectively deactivated by the damper pedal PD, loads imposed on the portion of the key 31 acting on the corresponding damper 36 while the key 31 is moved over one stroke in at least one of the key-depressing and key-releasing directions in association with a plurality of stroke positions in the one stroke of the key 31. Then, compensated loads are calculated by the offset loads being canceled (or subtracted) from the loads measured with the damping action of the dampers 36 not collectively deactivated by the damper pedal PD. Then, for each of the keys 31, the key-damper half region is identified on the basis of relationship between the individual stroke positions and the compensated loads corresponding to the stroke positions.

More specifically, first, the CPU 11 obtains a second curve indicative of relationship between the individual stroke positions of the key 31 and loads (i.e., offset loads) on the key drive unit 20, with the pedal PD kept positioned closer to a depression end than the half pedal region (i.e., with the damping action of the dampers 36 collectively deactivated by the pedal PD). Then, on the basis of the curve CA and the thus-obtained second curve related to the offset loads, the CPU 11 may obtain a curve indicative of relationship between the individual stroke positions of the key 31 and loads on the key drive unit 20 with only a load applied from the damper 36 reflected therein.

Namely, in performing the load characteristic curve calculation process of FIG. 8 in the alternative embodiment, the CPU 11 not only obtains the aforementioned curve CA but also obtains the second curve related to the offset loads by performing the operations of step S202 to S209 of FIG. 8 with the pedal PD kept positioned closer to the depression end than the half pedal region. While the curve CA includes loads based on weights of the damper 36 and the key drive unit 20, the offset-load-related second curve has only such loads based on the weights of the damper 36 and the key drive unit 20 removed therefrom. Thus, by subtracting (canceling) the offset-load-related second curve from the curve CA, the CPU 11 calculates compensated loads and obtains a curve related to the compensated loads. Because the thus-obtained compensated-load-related curve has only the load from the damper 36 reflected therein, the CPU 11 identifies two sudden change points for the compensated-load-related curve by performing the operations of steps S102 to S104, on the basis of which the CPU 11 identifies a key-damper half region and determines a half point HP. In this way, the key-damper half region can be identified with an even higher accuracy.

Whereas the internal division ratio to be used for determining the half point HP is “1:1” in the above-described embodiment, the present invention is nor so limited, The internal division ratio may be set at an appropriate value evaluated in advance by experiment or the like depending, for example, on the type of the keyboard musical instrument; such an appropriate value differs between upright pianos and grand pianos.

In the alternative embodiment, a half point HP common to a key group of a plurality of the keys may′ be determined on the basis of half points HP determined for the individual keys 31, in a statistical manner, e.g., by calculating an average value or appropriate representative value of the half points 1-IP of the individual keys 31.

Note that the driving of the key 31 for obtaining the load characteristic curve CA need not necessarily be at a constant speed as noted above and such driving of the key 31 may be executed in any desired manner as long as the key 31 is controlled to be always positioned at a target position. Therefore, the means for driving the key 31 is not limited to the key drive unit 20 using the solenoid 20a and may be any desired mechanism. Further, the construction for controlling the driving of the key 31 to be always positioned at a target position is also not limited to the control by the motion controller 41, servo controller 42 etc. using the half-point identifying drive data, and the key 31 may be operated manually.

Further, the present invention is not limited to the measurement of the load characteristic curve CA based on the aforementioned dynamic driving and may obtain the load characteristic curve CA through static or quasi-static driving. For example, the present invention may be arranged to obtain the load characteristic curve CA by plotting electric current instructing values uk(st) output for maintaining a static state of the key 31 at individual ones of a plurality of positions of the key 31.

Further, whereas, in the load characteristic curve CA, detection signals of the key sensor unit 37, i.e. measured values of the stroke positions, are employed as the values to be represented on the horizontal axis, the present invention is not so limited, and target values or instructing values rather than the measured values may be used as information indicative of the stroke positions of the key 31; for example, the information indicative of the stroke positions of the key 31 may be MIDI values (such as depression depth values) defining operation or movement of the key 31.

Further, the values to be represented on the vertical axis in the load characteristic curve CA are not limited to electric current instructing values uk(st) of the key drive unit 20 as long as they are load information indicative of loads imposed on the portion of the key 31 acting on the damper 36. For example, physical information corresponding to loads, such as solenoid coil currents, may be observed, and observed values of such physical information may be used as the values to be represented on the vertical axis. Alternatively, a pressure sensor or strain sensor may be provided on a portion related to the above-mentioned portion of the key 31 acting on the damper 36, so as to directly detect loads imposed on the acting portion. As another alternative, thrust force of the solenoid may be calculated on the basis of the information of the electric current instructing values uk(st) and positions of the key 31 and previously-examined thrust force characteristic of the solenoid, and the thus-calculated thrust force may be used as the load information.

Also note that the sounding element to be damp-controlled by the damper 36 in the present invention is not limited to the string set 34 and may be any other type of vibration source than the string set 34.

It should be appreciated that the object of the present invention can also be accomplished by supplying a system or apparatus or device with a storage medium having stored therein program codes of software implementing the functions of the above-described embodiments so that a computer (e.g., CPU 11, MPU or the like) of the system or apparatus or device reads out and executes the program codes stored in the storage medium. In such a case, the program codes read out from the storage medium themselves implement the functions of the present invention, and the storage medium having stored there in the program codes implements the present invention.

Furthermore, the storage medium for supplying the program codes may be, for example, a floppy (registered trademark) disk, hard disk, magneto-optical disk, CD-ROM, CD-R, CD-RW, DVD-ROM, DVD-RAM, DVD-RW, DVD+RW, magnetic tape, non-volatile memory card, ROM or the like. As an alternative, the program codes may be downloaded from a server computer via a communication network.

Moreover, whereas the functions of the above-described embodiment of the invention have been described above as implemented by a computer reading out and executing the program codes, they may of course be implemented by an OS and the like, running on the computer, performing a part or whole of the actual processing on the basis of the instructions of the program codes so that the functions of the described embodiment are implemented.

Furthermore, needless to say, the program codes, read out from the storage medium, may be written into a memory provided on a function extension board inserted in the computer or on a function extension unit connected to the computer so that the functions of the above-described embodiment can be implemented by a CPU and the like, provided on the function extension board or the function extension unit, performing a part or whole of the actual processing on the basis of the instructions of the program codes.

This application is based on, and claims priority to, JP PA 2013-082848 filed on 11 Apr. 2013. The disclosure of the priority application, in its entirety, including the drawings, claims, and the specification thereof, are incorporated herein by reference.

What is claimed is:

1. A method for identifying a key-damper half region in a keyboard musical instrument, the keyboard musical instrument including: a plurality of keys; a plurality of dampers provided in corresponding relation to the keys and each configured to activate its damping action in response to release of a corresponding one of the keys and deactivate its damping action in response to depression of the corresponding key; and a damper pedal configured to be capable of deactivating the damping action of the plurality of dampers, said method comprising:
a measurement step of measuring, for each of the keys and with the damping action of the plurality of dampers not deactivated by the damper pedal, loads imposed on a portion of the key acting on the damper while the key is moved over one stroke in at least one of key-depressing and key-releasing directions, in association with individual ones of a plurality of stroke positions in the one stroke of the key; and
an identification step of identifying, for each of the keys, the key-damper half region based on relationship between the individual stroke positions and the loads, measured by said measurement step, corresponding to the individual stroke positions.

2. The method as claimed in claim 1, wherein, for each of the keys, said identification step identifies two sudden change points where a curve indicative of the relationship between the individual stroke positions and the measured loads corresponding to the individual stroke positions suddenly changes in inclination, and the key-damper half region is identified based on the identified sudden change points.

3. The method as claimed in claim 1, which further comprises a step of determining a half point for each of the keys based on the key-damper half region identified for the key.

4. The method as claimed in claim 1, which further comprises a step of determining a half point common to a key group of a plurality of the keys based on the key-damper half region identified for each of the keys.

5. The method as claimed in claim 1, wherein the keyboard musical instrument further includes key drive units provided in corresponding relation to the keys and configured to be capable of driving the plurality of keys independently of each other, and
wherein said measurement step measures, for each of the keys, loads imposed on the key drive unit while the key is moved over one stroke in at least one of the key-depressing and key-releasing directions, in association with the individual stroke positions in the one stroke of the key.

6. The method as claimed in claim 5, wherein, in said measurement step, the key is moved at a substantially constant speed over the one stroke in at least one of the key-depressing and key-releasing directions.

7. The method as claimed in claim 5, wherein said measurement step measures loads imposed on the key drive unit while the plurality of keys are simultaneously moved by the key drive unit over the one stroke in at least one of the key-depressing and key-releasing directions, in association with the individual stroke positions in the one stroke of each of the keys.

8. The method as claimed in claim 1, which further comprises a step of measuring, as offset loads for each of the keys and with the damping action of the plurality of dampers deactivated by the damper pedal, loads imposed on the portion of the key acting on the damper while the key is moved over the one stroke in at least one of the key-depressing and key-releasing directions, in association with the individual stroke positions in the one stroke of the key,
and wherein said identification step includes a step of calculating compensated loads by canceling the offset loads from the loads measured by said measurement step with the damping action of the plurality of dampers not deactivated by the damper pedal, and, for each of the keys, said identification step identifies the key-damper half region based on the relationship between the individual stroke positions and the compensated loads corresponding to the individual stroke positions.

9. An apparatus for identifying a key-damper half region in a keyboard musical instrument, the keyboard musical instrument including: a plurality of keys; a plurality of dampers provided in corresponding relation to the keys and each configured to activate its damping action in response to release of a corresponding one of the keys and deactivate its damping action in response to depression of the corresponding key; and a damper pedal configured to be capable of deactivating the damping action of the plurality of dampers, said apparatus comprising
a processor configured to:
measure, for each of the keys and with the damping action of the plurality of dampers not deactivated by the damper pedal, loads imposed on a portion of the key acting on the damper while the key is moved over one stroke in at least one of key-depressing and key-releasing directions, in association with individual ones of a plurality of stroke positions in the one stroke of the key; and
identify, for each of the keys, the key-damper half region based on relationship between the individual stroke positions and the measured loads corresponding to the individual stroke positions.

10. An apparatus for identifying a key-damper half region in a keyboard musical instrument, the keyboard musical instrument including: a plurality of keys; a plurality of dampers provided in corresponding relation to the keys and each configured to activate its damping action in response to release of a corresponding one of the keys and deactivate its damping action in response to depression of the corresponding key; and a damper pedal configured to be capable of deactivating the damping action of the plurality of dampers, said apparatus comprising
a sensor provided for each of the keys for detecting a stroke position of the key;
a measurement unit configured to measure, for each of the keys, a load imposed on a portion of the key acting on the damper;
a first control device configured to measure, for each of the keys and with the damping action of the plurality of dampers not deactivated by the damper pedal, loads imposed on the portion of the key acting on the damper while the key is moved over one stroke in at least one of key-depressing and key-releasing directions, in association with individual ones of a plurality of stroke positions in the one stroke of the key, via the sensor and the measurement unit; and
a second control device configured to measure, for each of the keys, the key-damper half region based on relationship between the individual stroke positions and the loads, measured by said measurement unit, corresponding to the individual stroke positions.

11. A non-transitory computer-readable storage medium storing a program executable by a processor for implementing a method for identifying a key-damper half region in a keyboard musical instrument, the keyboard musical instrument including: a plurality of keys; a plurality of dampers provided in corresponding relation to the keys and each configured to activate its damping action in response to release of a corresponding one of the keys and deactivate its damping action in response to depression of the corresponding key; and a damper pedal configured to be capable of deactivating the damping action of the plurality of dampers, said method comprising:
a measurement step of measuring, for each of the keys and with the damping action of the plurality of dampers not deactivated by the damper pedal, loads imposed on a portion of the key acting on the damper while the key is moved over one stroke in at least one of key-depressing and key-releasing directions, in association with individual ones of a plurality of stroke positions in the one stroke of the key; and
an identification step of identifying, for each of the keys, the key-damper half region based on relationship between the individual stroke positions and the loads, measured by said measurement step, corresponding to the individual stroke positions.
